(19) United States
(12) Patent Application Publication
(10) Pub. No.: US 2025/0335409 A1
(43) Pub. Date: Oct. 30, 2025

(54) TRANSACTION GRAPH GENERATOR FRAMEWORK

(71) Applicant: WELLS FARGO BANK, N.A., San Francisco, CA (US)

(72) Inventors: Kasiperumal Achappan, Bengaluru (IN); Ramya Balasubramanian, Secunderabad (IN); Rajagopalan Krishnamoorthy, Chennai (IN)

(21) Appl. No.: 19/187,798

(22) Filed: Apr. 23, 2025

Related U.S. Application Data
(60) Provisional application No. 63/640,264, filed on Apr. 30, 2024.

(51) Int. Cl. G06F 16/22; G06F 16/2455

(52) U.S. Cl. CPC G06F 16/2228; G06F 16/2455

(57) ABSTRACT

Systems and methods for managing data using knowledge graphs are provided. A method receiving, by a processor, an input record. The method may also include loading, by the processor, a configuration file comprising commands that cause the processor to query a data source to extract application log data associated with the input record and map the application log data to transaction graph data. The method may also include traversing, by the processor, the transaction graph data to identify one or more anomalous components in the transaction graph data. The method may also include outputting, by the processor, a signal associated with an indication of the one or more identified anomalous components.

### CROSS-REFERENCE TO RELATED APPLICATIONS

This application claims the benefit of and priority to U.S. Provisional Patent Application No. 63/640,264, filed on Apr. 30, 2024, entitled “TRANSACTION GRAPH GENERATOR FRAMEWORK,” the disclosure of which is hereby incorporated by reference in its entirety for all purposes.

### TECHNICAL FIELD

The present disclosure generally relates to computer-based systems and methods for managing data using knowledge graphs. M ore specifically, but not by way of limitation, this disclosure relates to techniques for converting application log data into a transaction graph using a transaction graph generator framework.

### BACKGROUND

In the complex landscape of information technology (IT) systems, application logs include valuable data for understanding technical problems that persist in IT systems. However, application logs are typically underexploited for a variety of reasons. One such reason is the unstructured nature of the data contained in the application logs. Other reasons include the velocity in which data is populated into the application logs, the volume of the data, the variety of the data, the difficulties involved in drawing inferences between the data, the inconsistencies involved in logging formats, and the lack of business insights into the data. Conventional techniques for processing application log data involve a utilization of advanced natural language processing (NLP) or large language models (LLMs) employing machine learning (ML) and artificial intelligence (AI). Such techniques are computationally intensive, are not trained for application domain specific knowledge, require large training data, can be less accurate, and often times require manual review. Other conventional techniques provide observability tools to generate application graphs for non-functional parameter monitoring (e.g., latency, resiliency, error/exceptions, tracing, etc.); however, these observability tools are not capable of generating knowledge graphs at the transaction level.

Despite progress made in the field of knowledge graphs, there remains a need for improved techniques for converting application log data into a transaction graph at the transaction level for functional and behavioral investigation in a manner that is less computationally intensive yet remaining robust and efficient.

### SUMMARY

Certain aspects and features of the present disclosure generally relate to computer-based systems and methods for managing data using knowledge graphs. More particularly, but not by way of limitation, the present disclosure relates to techniques for converting application log data into a transaction graph using a transaction graph generator framework. According to an aspect of the present disclosure, a system for generating a transaction graph is provided. The system can include one or more processors. The system can also include one or more memories. The one or more memories can include instructions executable by the one or more processors to cause the one or more processors to: receive an input record, wherein the input record includes a duration load value and a unique customer identifier; load a configuration file comprising commands that cause the processor to: query a data source to extract application log data associated with the unique customer identifier and recorded within the duration load value; and map the application log data to transaction graph data comprising a set of components connected by a set of edges, wherein a combination of the set of components defines a type of transaction and each edge in the set of edges represents a relationship between connected components of the set of components; traverse the transaction graph data to identify one or more anomalous components in the transaction graph data, wherein each component of the transaction graph data is accessible by traversing the set of edges; and output a signal associated with an indication of the one or more identified anomalous components.

The above system may be implemented in a cloud service executed on cloud service provider infrastructure, which may include various servers, processors, and databases. The above system can also be implemented as computer-executable program instructions stored in a non-transitory, tangible computer-readable medium or media and/or operating within a system including one or more processors or other processing device and memory.

According to an additional aspect of the present disclosure, a method includes receiving, by a processor, an input record, wherein the input record includes a duration load value and a unique customer identifier; loading, by the processor, a configuration file comprising commands that cause the processor to: query a data source to extract application log data associated with the unique customer identifier and recorded within the duration load value; and map the application log data to transaction graph data comprising a set of components connected by a set of edges, wherein a combination of the set of components defines a type of transaction and each edge in the set of edges represents a relationship between connected components of the set of components; traversing, by the processor, the transaction graph data to identify one or more anomalous components in the transaction graph data, wherein each component of the transaction graph data is accessible by traversing the set of edges; and outputting, by the processor, a signal associated with an indication of the one or more identified anomalous components.

An additional example includes a non-transitory computer-readable medium embodying program code that is executable by one or more processors to cause the one or more processors to: receive an input record, wherein the input record includes a duration load value and a unique customer identifier; load a configuration file comprising commands that cause the processor to: query a data source to extract application log data associated with the unique customer identifier and recorded within the duration load value; and map the application log data to transaction graph data comprising a set of components connected by a set of edges, wherein a combination of the set of components defines a type of transaction and each edge in the set of edges represents a relationship between connected components of the set of components; traverse the transaction graph data to identify one or more anomalous components in the transaction graph data, wherein each component of the transaction graph data is accessible by traversing the set of edges; and output a signal associated with an indication of the one or more identified anomalous components.

### BRIEF DESCRIPTION OF THE DRAWINGS

Various non-limiting embodiments are further described with reference to the accompanying drawings, in which:

FIG. 1 is a block diagram illustrating an example of a transaction graph generator framework, according to some aspects of the present disclosure;

FIG. 2 illustrates an example of a process for generating a transaction graph, according to some aspects of the present disclosure;

FIG. 3 is a block diagram illustrating an example of a transaction graph, according to some aspects of the present disclosure; and

FIG. 4 is a block diagram illustrating an example of a computing system usable to implement some aspects of the present disclosure.

FIG. 5 is a flowchart illustrating an example process for converting application log data into a transaction graph using a transaction graph generator framework.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs.

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Example for Converting Application Log Data into a Transaction Graph Using a Transaction Graph Generator Framework

In computing systems, application logging may involve a processor performing operations to keep a log of events that occur within a computing system. These events may include problems that arise within the computing system, errors, or routine status records of current operations. Other examples of events may include memory leaks, non-existent path errors, system crashes, memory space warnings, server restarts, loss of network access, access authentication (e.g., login success/failure), software updates, and the like. When an event occurs that affects the computing system, software applications write the relevant log information to a file. An application log may be a file that stores the data associated with the event. IT service operators may then use the application logs to investigate the events (e.g., investigate outages, troubleshoot bugs, analyze security threats, etc.) to determine the root cause of the incidents, for example. Thus, application logs may be a record of events occurring on a computing system and generated by software applications. Application logs include an immense amount of information about the status of a computing system which in turn provides immense value to service operators who seek to understand and diagnose technical problems within a computing system.

A knowledge graph utilizes a graph-structured data model or topology to organize information in a structured way. Knowledge graphs are often utilized to store interlinked descriptions between entities (e.g., objects, events, situations, or abstractions). The entities of knowledge graphs may be referred to as nodes and the interlinked relationships between the nodes may be referred to as edges. Knowledge graphs can be used in, for example, searching, recommendation systems, question answering, virtual assistants, and the like. Certain aspects and features of the present disclosure relate to building a configurable knowledge graph for a specific knowledge domain based on application logs. More particularly, the techniques described herein can convert application logs (e.g., the unstructured or semi-structured application log data) from an application log data source (e.g., Splunk) into a transaction graph (e.g., a knowledge graph) using a transaction graph generator framework. The generated transaction graph can be stored into a graph database management system to provide information about computing systems at the transaction level, and may be used, for example, for functional and behavioral investigation of computing systems in a manner that is computationally robust and efficient.

Example Systems for Converting Application Log Data into a Transaction Graph using a Transaction Graph Generator Framework

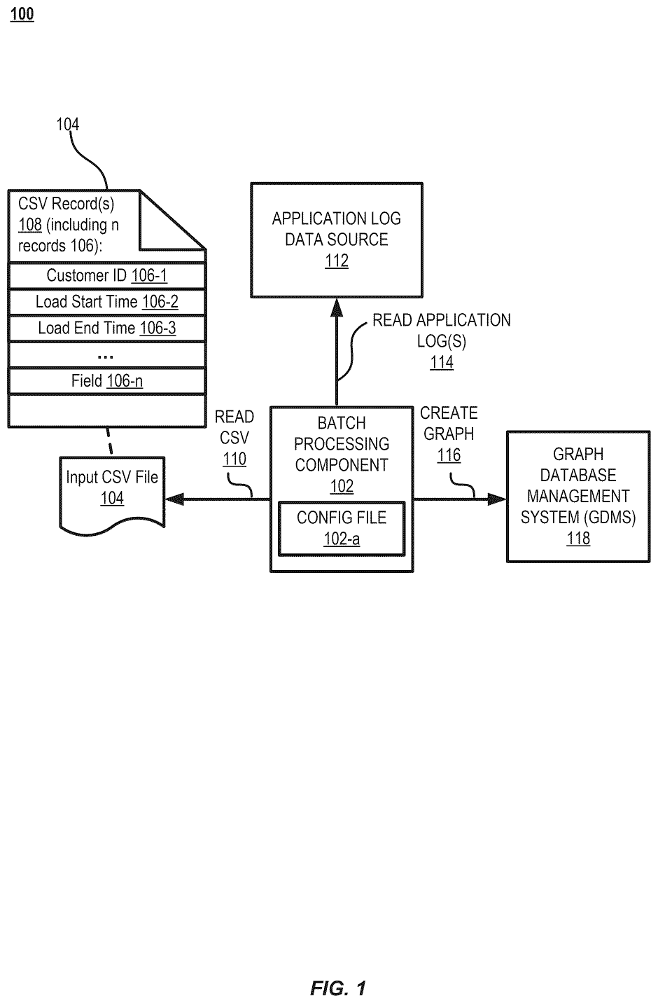

Turning now to the figures, FIG. 1 is a block diagram illustrating an example of a dynamic transaction graph generator framework 100, according to some aspects of the present disclosure. The framework includes a batch processing component 102. The batch processing component 102 can include one or more processors coupled to one or more memories. The one or more memories can include instructions that when executed by the one or more processors, cause the one or more processors to perform operations related to techniques described herein.

As illustrated by FIG. 1, the batch processing component 102 can be configured to read an input file via read CSV 110 command. In some implementations, the read CSV 110 command could be implemented by the batch processing component 102 executing a suitable application programming interface (API) call. The API call may accept the input CSV file 104 as input and the API call could parse the contents of the input CSV file 104. The API endpoint could additionally validate the file format of the input CSV file 104, ensuring the input CSV file 104 adheres to CSV standards, and then use a CSV parser or library (e.g., a Python or Java CSV module) to extract and structure the data (e.g., record(s) 108) into usable objects, such as arrays or dictionaries. The parsed data could then be processed further, stored in a database, or returned in a structured format (e.g., JSON) for downstream applications.

The input file can be comma separated value (CSV) file, as denoted by input CSV file 104 in FIG. 1. The input CSV file 104 can contain record(s) 108 (e.g., CSV field(s)) associated with transaction data (e.g., customer data) that may be used by the batch processing component 102 to generate a transaction graph. Each of the record(s) 108 in the input CSV file 104 can include a variety of fields describing particularities of a transactions associated with a customer (e.g., a user). As illustrated by FIG. 1, the input CSV file 104 can include a field describing a customer identifier 106-1, a field describing a load start time 106-1, and a field describing a load end time 106-3. Although the input CSV file 104 is illustrated as including three fields, other implementations may include additional fields depending on the particular application; thus, it will be appreciated that more or less fields are possible. Additionally, the load start time 106-2 and the load end time 106-3 records may collectively be referred to herein as “a load duration.” The load duration can be utilized by the batch processing component 102 to determine a relevant timeframe associated with the transaction for investigation, troubleshooting, and diagnosis purposes. That is, application log data within the load duration timing window is analyzed and application log data outside the load duration timing window is filtered.

The dynamic transaction graph generator framework 100 illustrated by FIG. 1 also includes an application log data source 112. The application log data source may be communicatively coupled to the batch processing component 102 via a network, for example. As illustrated in FIG. 1, the batch processing component 102 can also include one or more configuration files (e.g., config file 102-a). In some examples, the configuration file 102-a can be a JavaScript Object Notation (JSON) configuration file. The configuration file defines the application domain components and their relationship. The configuration file can also specify the application log data source 112 including instructions as to how the batch processing component 102 should extract the application logs and how to map the application logs. Similar to read CSV 110 command, batch processing component 102 may execute read application log(s) 114 command to extract and process the application log data from application log data source 112. Read application log(s) 114 command may be any suitable API call. The batch processing component 102 uses both the input CSV file 104 and the configuration file 102-a to dynamically create a transaction graph during runtime via create graph 116 command. The transaction graph is then stored into a graph database management system 118 for downstream access and analysis.

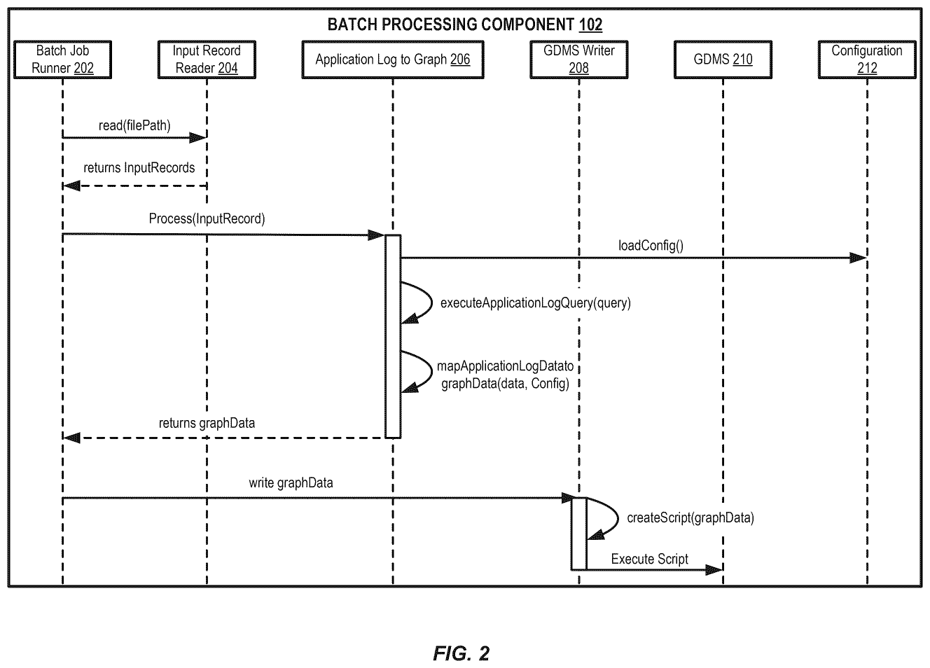

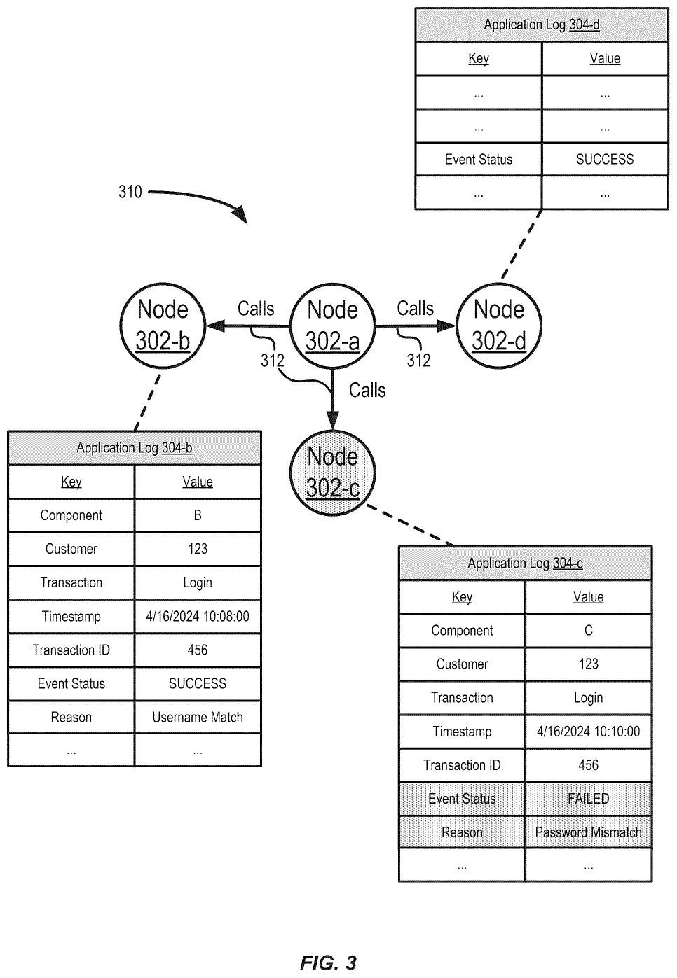

Staying with FIG. 1, based on the record(s) 108 extracted from the input CSV file 104, including the load duration, and the configuration file 102-a, the batch processing component 102 can execute a read application log(s) 114 command on the application log data source 112 to extract the application logs corresponding to the input CSV file 104. As described above, the application log data source 112 can be any type of logging software (e.g., Splunk, Datadog, etc.) that performs application logging functions on events occurring within computing systems. Using both the input CSV file 104 and the configuration file 102-a, a transaction graph can be dynamically created during runtime, where the configuration file 102-a can define the application domain components and their relationship. Once the batch processing component 102 generates the transaction graph data, the batch processing component 102 can perform a write operation to write the transaction graph data into graph database management system 118 (e.g., Neo4j®). Graph database management system 118 may refer to a suitable storage location for graph data that indicates relationships between the different entities (e.g., nodes) as illustrated by their edges connecting the nodes together. Graph generation as executed by create graph 116 command based on the input CSV file 104 and the configuration file 102-a is described in more detail below with respect to FIGS. 2 and 3.

FIG. 2 illustrates an example of a process for generating a transaction graph, according to some aspects of the present disclosure. As described above, generating a transaction graph is performed by the batch processing component 102 of FIG. 1. It will be appreciated that FIG. 2 provides an example process of the operations performed within the batch processing component 102 to dynamically generate a transaction graph according to the techniques described herein. Thus, FIG. 2 can be considered an interaction diagram that illustrates the processing operations that are performed within the batch processing component 102 for transaction graph generation.

Additionally, the process for generating a transaction graph as illustrated by FIG. 2 includes various layers of processing steps indicated by the vertical dashed lines. Each layer can correspond to a different processing device (e.g., processor) within the batch processing component 102. However, and in some examples, all the processing operations may be performed by a single processor. Additionally, the process illustrated by FIG. 2 illustrates a processing technique implemented by the batch processing component 102. In this way, the various layers can be considered conceptual layers that are separated for simplicity in understanding. It will be appreciated that each of the conceptual layers are implemented by the one or more processors, even though they may be described below as performing individual functions.

The first processing layer included in FIG. 2 is the batch job runner 202 processing layer where the batch processing component 102 receives the input CSV file 104. The input record reader 204 processing layer of the batch processing component 102 performs a read function on the input CSV file 104 at the input record reader processing layer to extract data from the input CSV file 104 (e.g., read CSV 110 command). The processor of the batch processing component 102 reads the input CSV file 104 and extracts all the record(s) 108 from the CSV file to be used for further processing. Additionally, and as mentioned above, the record(s) 108 extracted from the input CSV file 104 can include data that describes a customer identifier 106-1 and a load duration (e.g., a load start time 106-2 and a load end time 106-3). Once the processor of the input record reader 204 processing layer reads the input CSV file 104, the record(s) 108 are returned to the batch job runner 202 processing layer.

After the record(s) 108 are returned, the batch job runner 202 processing layer processes the record(s) 108 from the input CSV file 104 at the application log to graph 206 processing layer. In some examples, processing the record(s) 108 can include analyzing the load duration of the record(s) 108 to determine a time window for analysis. Additionally, the application log to graph 206 processing layer can load the configuration file 102-a from configuration 212 processing layer. As described with respect to FIG. 1, the configuration file 102-a can define the application domain components and their relationship. Once the configuration file 102-a is extracted and the record(s) 108 are processed, the application log to graph 206 processing layer queries the application log data source 112 for application logs associated with the record(s) 108 and configuration file 102-a. The application log to graph 206 processing layer then extracts the relevant application logs and maps the application log data to generate transaction graph data (e.g., graph data). To perform the mapping, the application log to graph 206 processing layer can map application log data to a knowledge graph by first parsing the application log data to extract relevant entities, relationships, and attributes. The parsing process may involve using log parsing tools or regular expressions to structure unstructured application log entries. The parsed data is then processed using rule-based prompts to identify key entities (e.g., users, systems, events) and their relationships (e.g., user-triggered-event, system-error). Once the application log data is formatted into a structured format, the structured application log data can be transformed into a format compatible with the knowledge graph schema (e.g., RDF triples or property graphs). The application log to graph 206 processing layer can implement specialized tools or libraries, such as Neo4j, to ingest the structured data and transform it into a knowledge graph format.

The resulting knowledge graph enables querying and analysis of log data, uncovering patterns, dependencies, or anomalies across systems, which can be utilized for troubleshooting, monitoring, or predictive analytics It will be appreciated that the graph data generated at the application log to graph 206 processing layer is dynamic in that it will vary depending on the particular record(s) 108 and the extracted application log data extracted from the particular time window for analysis. Thus, the graph data is not pre-programmed or stale, but rather updates in responses to the small changes in input. After the graph data is generated, the application log to graph 206 processing layer returns the graph data to the batch job runner 202 processing layer.

The next processing layer in the batch processing component 102 is the graph database management system (GDMS) writer 208 processing layer. The GDMS writer 208 receives the graph data generated by the application log to graph 206 processing layer and creates a script operable to write the graph data into GDMS 210. In general, GDMS 210 stores data elements as nodes. Nodes are connected by edges depending on the attributes of the nodes and edges. In some examples, the GDMS write 208 can convert the graph data to a cypher script and execute the write process on a common graph database management system such as Neo4j®, as mentioned above. However other specialized tools such as Apache Jena, RDF4J, and so on may be used. Additionally, it will be appreciated that there is no static object model employed in these processing steps. Instead, objectless graph mapping is done to dynamically create a script for graph creation.

FIG. 3 is a block diagram illustrating an example of a transaction graph 310, according to some aspects of the present disclosure. As illustrated in FIG. 3, the transaction graph 310 includes four components (e.g., node 302-a, 302-b, 302-c, 302-d) associated with a particular transaction that are generated based on the techniques described herein. Although four components are illustrated, it will be appreciated that more or less components are possible depending on the particular type of transaction and configuration. Additionally, the example transaction graph 310 of FIG. 3 includes a plurality of vertices 312 (e.g., edges), labeled as calls, representing relationships between the components. The calls may be unidirectional (as illustrated by FIG. 3) or bidirectional. One component (e.g., node 302-a) may be retrieved from another component (e.g., node 302-b) by traversing the transaction graph through the paths formed by the calls (e.g., edges). In one implementation, the components of the transaction graph 310 may be hierarchically arranged based on the duration load value such that each component is ordered in a sequential order. That is, component 302-a can be associated with a computing action that occurs before components 302-b, component 302-b can be associated with a computing action that occurs before component 302-c, and so on. Moreover, a transaction can be any form of interaction taken with a computing system. As one example, this could include a user attempting to login to their online account.

Also illustrated in FIG. 3 are application logs associated with the various nodes. For example, application log 304-b is illustrated and is associated with node 302-b, application log 304-c is illustrated and is associated with node 302-c, and application log 304-d is illustrated and is associated with node 302-d. Focusing on application log 304-c associated with node 302-c, the application log 304-c includes a variety of fields (e.g., records). For example, the application log 304-c includes a component value corresponding to the node, a customer value, a transaction indicator, a timestamp, a transaction ID, an event status, and a reason. The transaction graph 310 illustrated by FIG. 3 can be generated by the processing steps described above in relation to the input CSV file 104 and the configuration file 102-a described with respect to FIGS. 1 and 2. Referring back to FIG. 3, in some examples a computing system can traverse through the transaction graph starting at component A to perform anomaly detection.

To better demonstrate the techniques described herein, the following provides an illustrative example of how the teachings described in this disclosure may be applied to a particular use case. Suppose a sample transaction of a user attempting to access their online account (e.g., user login transaction) with application domain components represented by nodes 302-a, 302-b, 302-c, and 302-d and their corresponding relationships (e.g., vertices 312). Application domain components represented by nodes 302-a, 302-b, 302-c, and 302-d may correspond to functional aspects of the login transaction. For example, node 302-a may be associated with a start operation, node 302-b may be associated with a username input operation, node 302-c may be associated with a password input operation, and node 302-d may be associated with a password policy employed by an enterprise that maintains online accounts for users (e.g., the password must contain a certain number of letters, numbers, and special characters).

Continuing on with the illustrative example, suppose that a user attempts to perform a user login transaction; however, they are unable to successfully login. As a result, the user contacts the enterprise's customer support team to resolve the issue. When in contact with the enterprise customer support team, the user describes the issue to the agent by providing them with their name, when they tried to access their account, and the issue (e.g., unable to login). This information provided by the user may be associated with a customer identifier, and the timeframe, which can be stored into an input CSV file 104. The input CSV file 104, as described above, will contain the customer identifier, a load start time, and a load end time. The load start time may correspond to a time (e.g., date and time) sometime before the user attempted to access their online account. The load end time may correspond to a second time (e.g., a date and time) sometime after the user attempted to access their online account.

Once the input CSV file 104 is generated, a batch processing component 102, can read the input CSV file 104 to extract the CSV fields (e.g., customer identifier, load start time, and load end time). The CSV fields may be referred to as a record that is read by the input record reader 204 of the batch processing component 102. Once the records are returned, the application log to graph layer 206 of the batch processing component 102 loads a configuration file (e.g., configuration file 102-a) to begin performing processing steps to generate a transaction graph that can then be utilized by the enterprise to diagnose the issue.

The configuration file 102-a loaded by the application log to graph 206 processing layer can define the application domain components and their relationship. The configuration file 102-a may also specify the application log data source 112, how to extract the application log data, and how to map the application log data to the application domain components. Provided below is an example configuration defining node 302-a of the illustrative example. Configuration defining node 302-a could be represented as:
{
“nodes”: [
{
“name”: “A”.
“static_properties”: {
   “title”: “A”},
“input_properties”: {
   “customerIdentifier”: “customerIdentifier”
   }
},

In the example configuration of node 302-a, above, there is no application log data query configuration. Thus, graph data may be generated associated with node 302-a including a title and a static property of the customer identifier (e.g., the customer identifier from the input CSV file 104). The configuration file may further define application domain nodes 302-b, 302-c, and 302-d as follows:
{
“name”: “B”,
“static_properties”: {
   “title”: “B”
   },
“sources”: [
{
“sourceType”: “ApplicationLogDataSource”
“query”: “search index=xyz wf_id=APPSPACE source=\“*/app/*log*\”
event_name=ABC event_status=SUCCESS\“\\\”ecn\\\“:\\\”% s\\\“\”|
fields session_id, context.subcontext.customerIdentifier”,
“fields_mapping”: {
   “session_id”: “session_id”
   “context.subconext.customerIdentifier”: customerIdentifier”
},
“query_params_mapping”: [“customerIdentifier”],
“start_date_field”: “startDate”,
“end_date_field”: “endDate”
}
]},
{
“name”: “C”,
. . .
. . .
},
{
“name”: “D”,
. . .
. . .
}

The example configuration of application domain nodes 302-a, 302-b, 302-c, and 302-d may be done as represented above. As part of the configuration of nodes 302-b, 302-c, and 302-d, the batch processing component 102 performs a query of the application log data source as defined by the “query” field in the configuration above. Querying the application log data source can involve querying the application log data source 112 for the application log corresponding to the “event_name” for the given “customerldentifer” based on the load start time and load end time, for example. The application log data extracted from the query may then be mapped to graph data using the “fields_mapping” as defined in the representation above. The “fields_mapping” maps the value of the application log data “session_id” to graph data associated with node 302-b. Additionally, the “fields_mapping” maps the value of the application log data “context.subcontext.customerldentifier” to graph data associated with node 302-b. This context can be associated with a particular event corresponding to the user login transaction. Similar configuration and processing steps may be performed to generate nodes 302-c and 302-d and their corresponding graph data.

After defining each of nodes 302-a, 302-b, 302-c, and 302-d, the configuration file may then define the relationships between each of the application domain components. The relationships between each of the application domain components could be represented in the configuration file as:
“relationships”: [
{
“name”: “calls”,
“static_properties”: { },
“startNode”: “A”,
“endNode”: “B”,
“relation_map_props”: [“customer_id”]
},
{
“name”: “calls”,
“static_properties”: { },
“startNode”: “A”,
“endNode”: “C”,
“relation_map_props”: [“customer_id”]
},
{
“name”: “calls”,
“static_properties”: { },
“startNode”: “A”,
“endNode”: “D”,
“relation_map_props”: [“customer_id”]
},
]}

As demonstrated by the representation of the calls above, node 302-a shares a relationship (e.g., call) with each of nodes 302-b, 302-c, and 302-d associated with the transaction of the user login transaction. After the configuration file extracts the application log data for user (e.g., based on the customer identifier) for the relevant time period (e.g., between load start time and load end time) and maps the application log data to graph data (as represented in the example representation above), the batch processing component 102 can dynamically create a script to write the graph data to a GDMS 210 to provide a representation of the transaction graph 310.

Staying with the illustrative example, the transaction graph 310 may then be traversed by the enterprise to identify the friction point associated with the user login transaction. In this particular example transaction, component C highlights a failed event due to a password mismatch. The enterprise can then communicate this to the user to resolve the issue. The illustrative example is not intended to limit the present disclosure, but rather, it is provided as a simplified example intended to highlight the features described herein.

The illustrative example highlights the numerous benefits achieved by way of the present disclosure. For example, examples of the present disclosure provide for a robust and computationally efficient transaction graph generator framework that utilizes the immense amount of data stored within application logs to analyze technical problems at the transaction level (e.g., for a specific user). Application log data can contain thousands, hundreds of thousands, or even more data entries associated with transactions that may be difficult or impossible for a human to analyze on their own. Examples of the present disclosure take advantage configuration driven techniques to organize and present the application log data in a way that is readily interpretable for a human.

The present disclosure also provides for a transaction graph generator framework that is purely configuration driven. In other words, examples of the present disclosure utilize configuration data and files to control the behavior and functionality of underlying software applications without having to modify the code of the software applications. This is done by configuring the pre-existing data flow of transaction information and application logs. This configurability results in the framework being highly adaptable to domain specific knowledge (e.g., enterprise transactions) and pluggable for any application log data source.

The present disclosure also allows for transaction graph generation through normal batch processing. As a result, no additional graphic processing units (GPU) are required. This results in a savings of computational resources as well as an elimination in the need for manual intervention as graph generation can be performed without artificial intelligence or machine learning techniques. The configuration driven techniques utilized by the framework allow for integration of enterprise domain knowledge into the framework, rather than the computationally expensive process of training an artificial intelligence or machine learning model. The configuration driven techniques also eliminate the need for a static object model definition because the transaction graph can be dynamically created without changing pre-existing code (e.g., there is no static object model employed, instead objectless graph mapping is done by the configuration file and a dynamically create script is create to write the graph in a GDMS) thereby resulting in improvements to scalability and resilience for multiple applications and use cases.

The techniques described herein are applicable for a variety of other use cases in addition to the illustrative example above. One example of a use case, and similar to the user login example above, is to investigate customer friction and research. This use case focuses on analyzing user transactions over a selected time frame to identify and understand any friction points. By generating a transaction graph from application logs using specific configurations and inputs, the transaction graph visually represents interactions and processes involving a particular customer. The transaction graph helps in pinpointing areas where customers experience difficulties, such as error or failed transactions. This visual approach allows for easier identification of patterns or anomalies in the transaction flow, leading to a faster root cause analysis of issues affecting customer satisfaction. Ultimately, this use case optimizes customer service of an enterprise by addressing these friction points efficiently and proactively.

Another example of a use case of the techniques described herein is on-demand graph database data migration. In other words, through the generation of transaction graphs, the graph data can be transferred on-demand for any specific dataset from any sources (e.g., datastores or messaging platforms). In this example use case, the migration process utilizes a configuration that defines how data elements and their relationships are extracted from the source (e.g., application logs) and mapped to the transaction graph constructs (e.g., the nodes and edges). The configuration of the transaction graph can provide for maintaining the integrity and usability of the application logs in its new graph format, ensuring that relational dynamics are preserved and can be effectively analyzed.

Yet another example of a use case of the techniques described herein is real-time graph analytics processing. Real-time graph analytics processing uses dynamic transaction graphs to analyze data as it streams in real time (e.g., from platforms like Apache Flink®). This use case provides immediate insights into the relational dynamics of the transaction graph from continuously updating sources of data. By configuring the framework to integrate with a real-time data streaming platforms, the generated transaction graphs continuously update with new transactions and metrics are recalculated without batch processing delays. This capability provides instantaneous data analysis and decision-making, such as fraud detection in banking, real-time recommendation systems, live graph monitoring, and the like.

Another example of a use case of the techniques described herein is component impact analysis. This use case allows an enterprise to assess the impact of component failures within an application ecosystem. By using a graph that represents dependencies among various components, improvements in understanding which parts of the computing system are potentially affected by a downtime or malfunction. During an incident, the graph can be consulted to quickly visualize dependencies and evaluate the transactions impacted which facilitating rapid response and troubleshooting. This not only helps in reducing downtime but also aids in improving system resilience by highlighting critical vulnerabilities in the transaction flow.

Yet another use case of the techniques described herein is anomaly detection. Anomaly detection in transaction graphs involves comparing nodes and edges in different scenarios, such as successful vs. failed transactions or usual vs. unusual patterns. This use case leverages the transaction graph's ability to encapsulate complex relationships and behaviors in an easy visualization format. By examining deviations from normal patterns, the system can identify outliers and potential issues proactively. This is particularly useful for spotting fraud, security breaches, or operational inefficiencies. The graph-based approach provides a comprehensive overview, making it easier to diagnose problems and implement corrective measures efficiently.

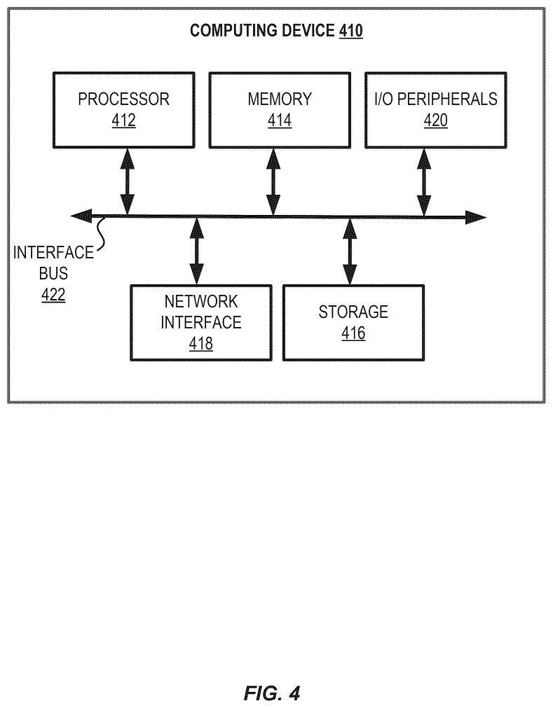

FIG. 4 is a block diagram illustrating an example of a computing device 410 usable to implement some aspects of the present disclosure. In one configuration, the computing device may include at least one processor 412 and at least one memory 414. Depending on the exact configuration and type of computing device, the at least one memory 414 may be volatile, such as RAM, non-volatile, such as ROM, flash memory, etc., or a combination thereof. Examples of processor 412 include a microprocessor, an application-specific integrated circuit (A SIC), a field-programmable gate array (FPGA), or any other suitable processing device. Computing device 410 can include one processor, such as is illustrated by processor 412 in FIG. 4, or more than one processor.

Computing device 410 may include additional features or functionality. For example, the computing device 410 may include additional storage such as removable storage or non-removable storage, including, but not limited to, magnetic storage, optical storage, etc. Such additional storage is illustrated in FIG. 4 by storage 416. In one or more embodiments, computer readable instructions to implement one or more embodiments provided herein are in the storage. The storage 416 may store other computer readable instructions to implement an operating system, an application program, etc. Computer readable instructions may be loaded in the at least one memory for execution by the at least one processor 412, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information. Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Still referring to FIG. 4, the computing environment may also include a number of additional external or internal devices, for example, input or output devices. For example, computing device is illustrated as including input/output (I/O) peripherals 420. I/O peripherals 420 can receive input from input device or provide output to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device. I/O peripherals 420 may be connected to the computing device 410 via a wired connection, wireless connection, or any combination thereof. In one or more embodiments, an additional computing device, such as computing device can be connected to computing device via network and be used as the input and output device for the computing device 410. Further, the computing device 410 may include network interface 418 to facilitate communications with one or more other devices, illustrated as a computing device coupled over a network. Network interface 418 can include any device or group of devices suitable for establishing a wired or wireless data connection to one or more data networks. Non-limiting examples of the network interface 418 include an Ethernet network adaptor, a wireless network adapter, and the like.

Interface bus 422 is also included in the computing device. Although only one interface bus is illustrated, the computing device can include more than one interface bus. Interface bus 422 can communicatively couple one or more components of computing device together.

Example Methods for Converting Application Log Data into a Transaction Graph using a Transaction Graph Generator Framework

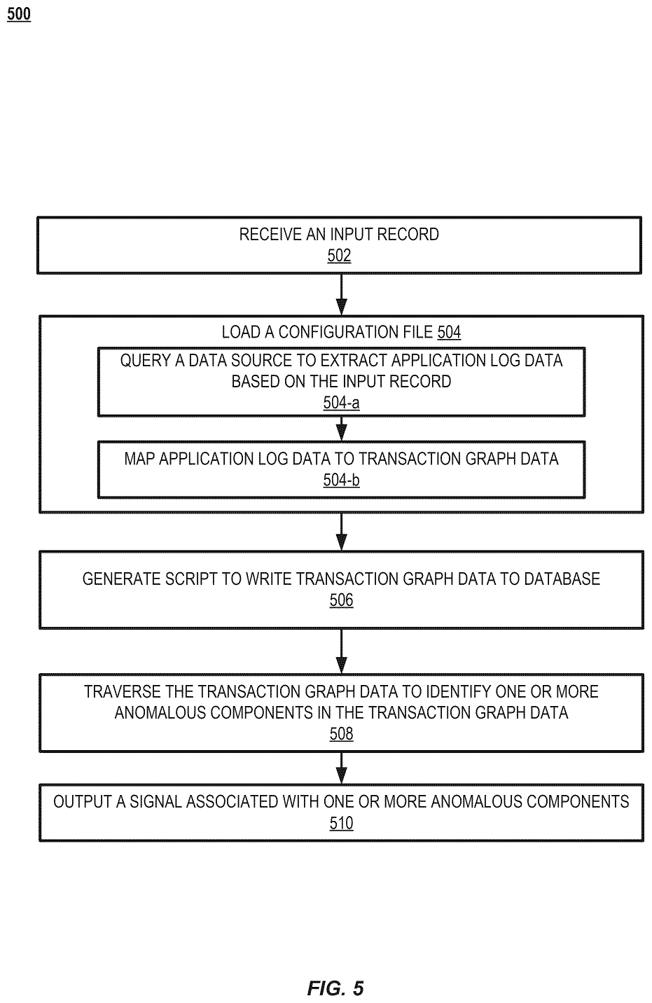

Turning now to FIG. 5, which is a flowchart illustrating an example process 500 for converting application log data into a transaction graph using a transaction graph generator framework. The process 500 will be described with respect to the transaction graph generator framework 100 including the batch processing component 102 usable to generate a transaction graph, such as transaction graph 310, as shown and described with respect to FIGS. 1-3; however, any suitable system or platform according to this disclosure may be employed, including the example computing device 410 shown in FIG. 4. Additionally, process 500 is provided in the order shown, but other orders or additional steps may be provided.

As shown in FIG. 5, process 500 begins at step 502 where the batch processing component 102 receives an input record. The input record can be the input CSV file 104. In one implementation, the batch processing component 102 can extract the input CSV file 104 via execution of an API call. In other implementations, the input CSV file 104 may be manually uploaded to generated by a user. As described with respect to FIG. 1, the input CSV file 104 can contain record(s) 108 (e.g., CSV field(s)) associated with transaction data (e.g., customer data) that may be used by the batch processing component 102 to generate a transaction graph. Each of the record(s) 108 in the input CSV file 104 can include a variety of fields describing particularities of a transactions associated with a customer (e.g., a user).

Next at step 504, the batch processing component 102 loads a configuration file 102-a. In some implementations, the configuration file 102-a may be preconfigured by a system administrator of the batch processing component 102. In addition, loading of the configuration file 102-a may be performed by the application log to graph 206 processing layer of the batch processing component 102. The configuration file 102-a can include various commands executable by a process of the batch processing component 102. For instance, as shown in process 500, the configuration file 102-a can include command 504-a instructing the processor of the batch processing component 102 to query a data source to extract application log data based on the input record. Configuration file 102-a can also include command 504-b instructing the processor of the batch processing component 102 to map application log data extracted from the data source to transaction graph data. In one implementation the data source may be application log data source 112. Application log data source 112 may be remotely accessible by batch processing component 102 via a network connection. In some implementations, application log data source 112 may be locally stored by batch processing component 102.

Next at step 506, the batch processing component 102 generates a script to write the transaction graph data to a database, such as graph database management system 118. In more detail, after the GDMS writer 208 receives the graph data generated by the application log to graph 206 processing layer and a script is created that is operable to write the graph data into GDMS 210. In general, GDMS 210 stores data elements as nodes. Nodes are connected by edges depending on the attributes of the nodes and edges. In some examples, the GDMS write 208 can convert the graph data to a cypher script and execute the write process on a common graph database management system such as Neo4j®, as mentioned above. However other specialized tools such as Apache Jena, RDF4J, and so on may be used. Additionally, and as mentioned with respect to FIG. 2, it will be appreciated that there is no static object model employed in these processing steps. Instead, objectless graph mapping is done to dynamically create a script for graph creation.

Next at step 508, the batch processing component 102 traverses the transaction graph data to identify one or more anomalous components in the transaction graph data. For example, the transaction graph 310 may then be traversed by a user or computing device enterprise to identify the friction point associated with a particular transaction (e.g., a user login transaction). In these examples, each node (e.g., component) of the transaction graph 310 can include a respective application log data extracted based on the duration load value. The respective application log data for each node can include an event status field, where the event status field indicates a success or a failure of a computing action associated with the node. The batch processing component 102 can traverse each node and analyze the respective application logs, include the event status field. For each node that includes an event status field with a failure indication, the batch processing component can label the particular component as “failed” (e.g., identify one or more anomalous components.

Next at step 510, the batch processing component 102 outputs a signal associated with the one or more anomalous components. In some embodiments, a visualization object associated with the transaction graph data may be output for display on a user interface of a computing device. The visualization object can visually display (e.g., highlight, color, flag) the one or more anomalous components.

### General Considerations

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A system comprising:
one or more processors; and
one or more memories including instructions executable by the one or more processors to cause the one or more processors to:
receive an input record, wherein the input record includes a duration load value and a unique customer identifier;
load a configuration file comprising commands that cause the processor to:
query a data source to extract application log data associated with the unique customer identifier and recorded within the duration load value; and
map the application log data to transaction graph data comprising a set of components connected by a set of edges, wherein a combination of the set of components defines a type of transaction and each edge in the set of edges represents a relationship between connected components of the set of components;
traverse the transaction graph data to identify one or more anomalous components in the transaction graph data, wherein each component of the transaction graph data is accessible by traversing the set of edges; and
output a signal associated with an indication of the one or more identified anomalous components.

2. The system of claim 1, wherein each component of the set of components comprises a computing action associated with the type of transaction.

3. The system of claim 1, wherein the duration load value comprises a start load value and an end load value defining a timing window, wherein the system is further configured to:
filter the application log data to remove application log data that is outside the timing window.

4. The system of claim 3, wherein the set of components are hierarchically arranged in the transaction graph data based on the timing window, such that each component is ordered in a sequential order, wherein the system is further configured to:
output, for display on a user computing device, a visualization object associated with the transaction graph data.

5. The system of claim 1, wherein the input record comprises a file comprising comma separated values.

6. The system of claim 1, wherein the system is further configured to:
generate a script to write the transaction graph data into a transaction graph database thereby generating a transaction graph.

7. The system of claim 1, wherein each component in the set of components comprises a respective application log data extracted based on the duration load value, wherein the respective application log data comprises an event status field defining a success or a failure of a computing action associated with the component.

8. The system of claim 7, wherein the system of further configured to:
analyze each event status field for each component; and
label each component comprising a failed event status field as anomalous.

9. The system of claim 1, wherein the system is further configured to:
transform the application log data to a structured format prior to mapping the application log data to transaction graph data.

10. A method comprising:
receiving, by a processor, an input record, wherein the input record includes a duration load value and a unique customer identifier;
loading, by the processor, a configuration file comprising commands that cause the processor to:
query a data source to extract application log data associated with the unique customer identifier and recorded within the duration load value; and
map the application log data to transaction graph data comprising a set of components connected by a set of edges, wherein a combination of the set of components defines a type of transaction and each edge in the set of edges represents a relationship between connected components of the set of components;
traversing, by the processor, the transaction graph data to identify one or more anomalous components in the transaction graph data, wherein each component of the transaction graph data is accessible by traversing the set of edges; and
outputting, by the processor, a signal associated with an indication of the one or more identified anomalous components.

11. The method of claim 10, wherein each component of the set of components comprises a computing action associated with the type of transaction.

12. The method of claim 10, wherein the duration load value comprises a start load value and an end load value defining a timing window, wherein the method further comprises:
filtering the application log data to remove application log data that is outside the timing window.

13. The method of claim 12, wherein the set of components are hierarchically arranged in the transaction graph data based on the timing window, such that each component is ordered in a sequential order, wherein the method further comprises:
outputting, for display on a user computing device, a visualization object associated with the transaction graph data.

14. The method of claim 10, further comprising:
generating a script to write the transaction graph data into a transaction graph database thereby generating a transaction graph.

15. The method of claim 10, wherein each component in the set of components comprises a respective application log data extracted based on the duration load value, wherein the respective application log data comprises an event status field defining a success or a failure of a computing action associated with the component.

16. The method of claim 10, further comprising:
transform the application log data to a structured format prior to mapping the application log data to transaction graph data.

17. The method of claim 15, further comprising:
analyzing each event status field for each component; and
labeling each component comprising a failed event status field as anomalous.

18. A non-transitory computer-readable medium comprising program code that is executable by a processor to cause the processor to:
receive an input record, wherein the input record includes a duration load value and a unique customer identifier;
load a configuration file comprising commands that cause the processor to:
query a data source to extract application log data associated with the unique customer identifier and recorded within the duration load value; and
map the application log data to transaction graph data comprising a set of components connected by a set of edges, wherein a combination of the set of components defines a type of transaction and each edge in the set of edges represents a relationship between connected components of the set of components;
traverse the transaction graph data to identify one or more anomalous components in the transaction graph data, wherein each component of the transaction graph data is accessible by traversing the set of edges; and
output a signal associated with an indication of the one or more identified anomalous components.

19. The non-transitory computer-readable medium of claim 18, wherein each component in the set of components comprises a respective application log data extracted based on the duration load value, wherein the respective application log data comprises an event status field defining a success or a failure of a computing action associated with the component.

20. The non-transitory computer-readable medium of claim 19, wherein the processor is further configured to:
analyze each event status field for each component; and
label each component comprising a failed event status field as anomalous.
